(19) United States
(12) Patent Application Publication
(10) Pub. No.: US 2004/0254838 A1
(43) Pub. Date: Dec. 16, 2004

(54) System and method for dynamically and adaptively delivering special offerings in a network environment

(76) Inventors: Jin Guo, Cupertino, CA (US); Peng Tao, Foster City, CA (US); Yan Zhang, Los Altos, CA (US)

Correspondence Address: FORTUNE LAW GROUP, 100 Century Center Ct., San Jose, CA, 95112, US

(21) Appl. No.: 10/851,046

(22) Filed: May 21, 2004

Related U.S. Application Data
(60) Provisional application No. 60/473,083, filed on May 23, 2003.

(51) Int. Cl. G06F 17/60

(52) U.S. Cl. 705/14

(57) ABSTRACT

A method for dynamically and adaptively delivering special offerings in a network environment includes the steps of categorizing a content of contexts and special offerings, analyzing and indexing information carrying units from the special offerings, pre-locating the indexed information carrying units in the contexts, associating categorized special offerings with the pre-located information carrying units in the contexts, tagging the pre-located information carrying units in the contexts, receiving a request from a user for a context, and serving the tagged context to the user.

### CROSS REFERENCE TO RELATED APPLICATIONS

The present application claims priority under 35 U.S.C. 119(e) from provisional patent application Ser. No. 60/473,083, entitled “A Method of Dynamically and Adaptively Delivering Special Offerings in a Network Environment”, filed on May 23,2003, the disclosure of which is herein incorporated by reference in its entirety.

### BACKGROUND OF THE INVENTION

The present invention relates to systems and methods of delivering special offerings which reflect the content being viewed by a user as well as the interests of the user.

It is well known in the art to deliver and present to an end user special offerings as the user is browsing an interactive network such as the World Wide Web. Such special offerings include advertisements in the form of banner ads, plain text ads, pop-up ads, and fly over ads. These advertisements represent a tremendous commercial opportunity to advertisers and interactive network businesses such as search engine providers and content providers. These businesses have sought to provide special offerings to the end user more effectively and precisely.

However, conventional online advertising systems and methods for targeting user's interests are not very precise. For example, and as shown in FIG. 1, a system developed by DoubleClick of New York, N.Y. includes broad web site categorization and rough location estimation from IP addresses. This system does not categorize the content of the web page being viewed and fails to determine the user's browsing, searching, and shopping interests. Because of this, users may not be interested in the special offerings inserted in the viewed web pages. DoubleClick delivered 600 billion ads in 2002 with very low click-through and conversion rates. An example of poorly targeted advertisements displayed on a web page is shown in FIG. 1A in which banner ads for a health care plan and a car dealer are displayed on a web page displaying an article about stock and oil prices.

In order to solve the problem of low user interest in inserted special offerings, prior art systems and methods use multi-media methods such as pop-up, pop-under, and fly over ads. However, these methods are very intrusive and annoying to the user and distract the user from his browsing activity. Further, such methods may adversely affect the relationship between the user and the business being advertised. An example of pop-up ads is shown in FIG. 1B.

Targeted advertising has been more effective when coupled with more specific knowledge of the user's interest. A system developed by Google of Mountain View, Calif. is shown in FIG. 2. The system targets the user's interest based on the user's search query. Although this system provides for targeting of the user's interest, most of the user's online experience includes browsing and search traffic is steadily decreasing. An example of such targeted advertising is shown in FIG. 2A. Text ads 200 related to digital cameras are displayed alongside search results returned in response to the search query “digital camera”. This system is limited in the case where no advertising is related to the search query. For example, no targeted advertising is shown in FIG. 2B for the search query “John McDonald”.

Other prior art systems include functionality added to client-side browsers operable to select particular pre-defined words on a web page and hyperlink these words to various pre-designated websites corresponding to the words. However these systems do not associate special offerings dynamically and are limited to client-side browsers.

Accordingly, there is a need in the art for a system and method for dynamically and adaptively delivering special offerings in a network environment. Preferably such a system and method provides highly targeted special offerings without intruding upon the user's online experience.

### SUMMARY OF THE INVENTION

In accordance with the present invention, a method for dynamically and adaptively delivering special offerings in a network environment includes the steps of categorizing a content of contexts and special offerings, analyzing and indexing information carrying units from the special offerings, pre-locating the indexed information carrying units in the contexts, associating categorized special offerings with the pre-located information carrying units in the contexts, tagging the pre-located information carrying units in the contexts, receiving a request from a user for a context, and serving the tagged context to the user.

In accordance with an alternate embodiment of the present invention, a method for dynamically and adaptively delivering special offerings in a network environment includes the steps of categorizing a content of contexts and special offerings, analyzing and indexing information carrying units from the special offerings, receiving a user personal profile, receiving user feedback statistics, pre-locating the indexed information carrying units in the contexts based on the content of the contexts, the user personal profile, and user feedback statistics, associating categorized special offerings with the pre-located information carrying units in the contexts, tagging the pre-located information carrying units in the contexts, receiving a request from a user for a context, and serving the tagged context to the user.

These and other features, aspects and advantages of the present invention will become better understood with reference to the following drawings, description and claims.

### BRIEF DESCRIPTION OF THE DRAWINGS

FIG. 1 is a flow chart representation of a prior art online advertising system;

FIG. 1A is a screen shot of a prior art web page showing delivered advertising;

FIG. 1B is a screen shot showing prior art pop-up advertisements;

FIG. 2 is a flow chart representation of an alternative prior art online advertising system;

FIG. 2A is a screen shot showing prior art text advertisements;

FIG. 2B is a screen shot showing prior art search results;

FIG. 3 is a flow chart representation of an offline process for dynamically and adaptively delivering special offerings in a network environment in accordance with an embodiment of the invention;

FIG. 4 is a flow chart representation of a process for analyzing user feedback in accordance with an embodiment of the invention;

FIG. 5 is flow chart representation of a process for analyzing user personal interests in accordance with an embodiment of the invention;

FIG. 5A is a schematic representation of a user personal interest profile in accordance with an embodiment of the invention;

FIG. 6 is a flow chart representation of an online process for dynamically and adaptively delivering special offerings in a network environment in accordance with an embodiment of the invention;

FIG. 7 is a schematic representation of various tables in accordance with an embodiment of the invention;

FIG. 8 is a screen shot of a served web page in accordance with an embodiment of the invention;

FIG. 9 is a screen shot of an alternative served web page in accordance with an embodiment of the invention;

FIG. 10 is a screen shot of yet another alternative served web page in accordance with an embodiment of the invention;

FIG. 11 is a flow chart of an offline method for dynamically and adaptively delivering special offerings in a network environment in accordance with an embodiment of the invention; and

FIG. 12 is a flow chart of an online method for dynamically and adaptively delivering special offerings in a network environment in accordance with an embodiment of the invention.

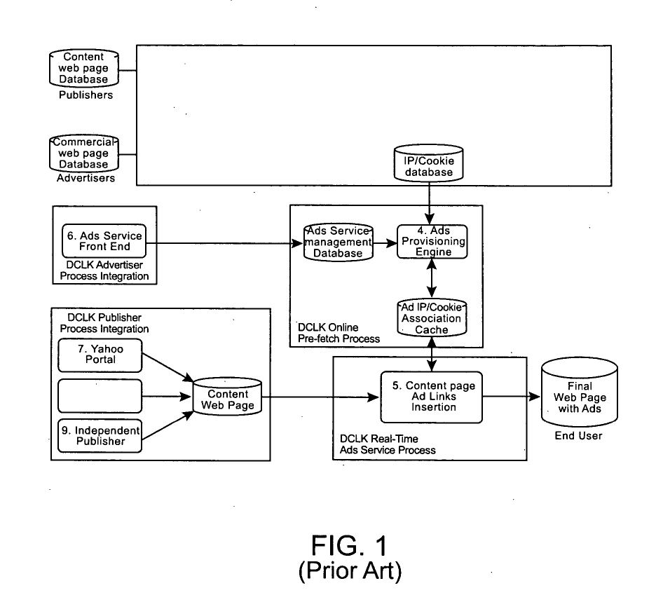

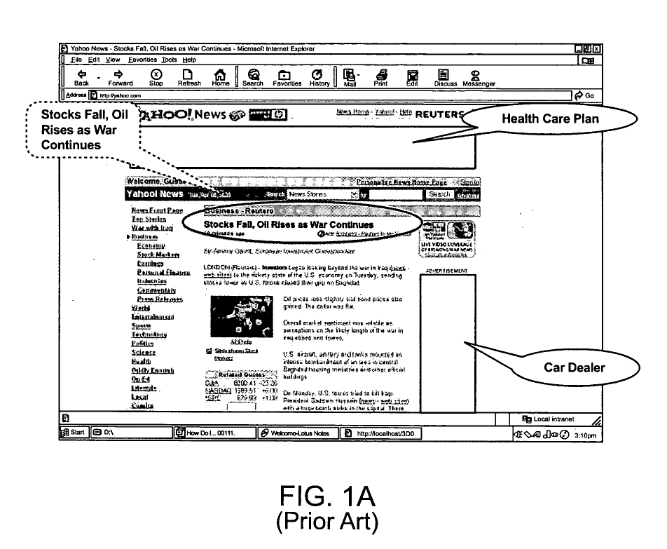

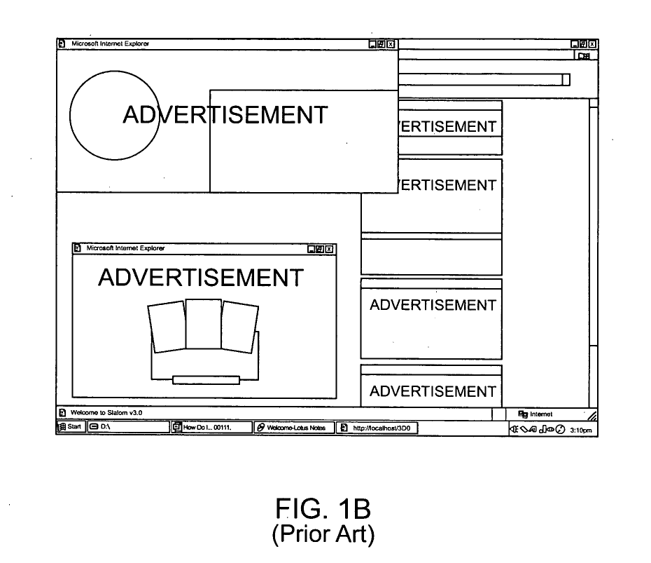

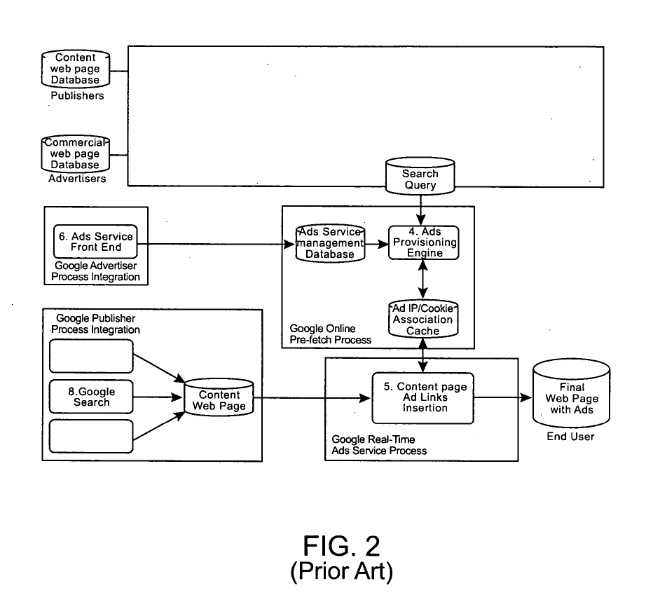

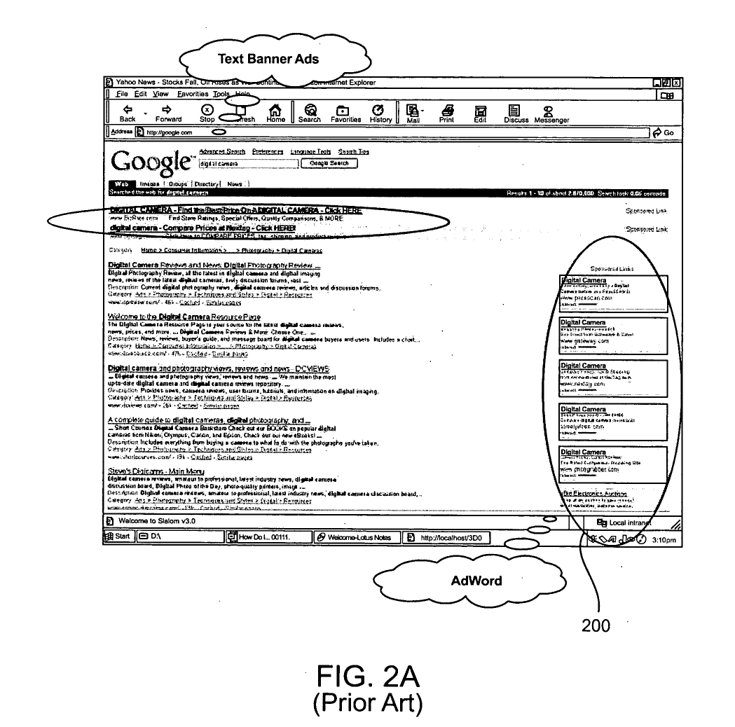

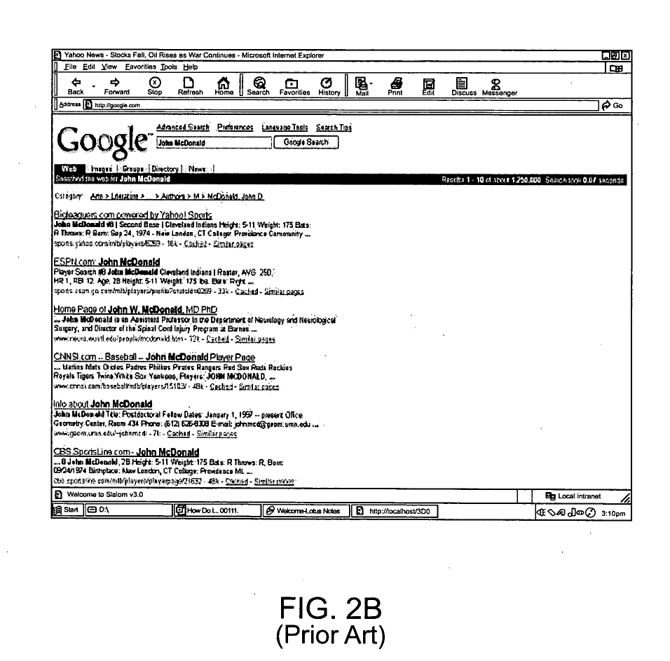

### DETAILED DESCRIPTION OF THE INVENTION

The following detailed description is of the best currently contemplated modes of carrying out the present invention. The description is not to be taken in a limiting sense, but is made merely for the purpose of illustrating the general principles of the invention, since the scope of the invention is best defined by the appended claims.

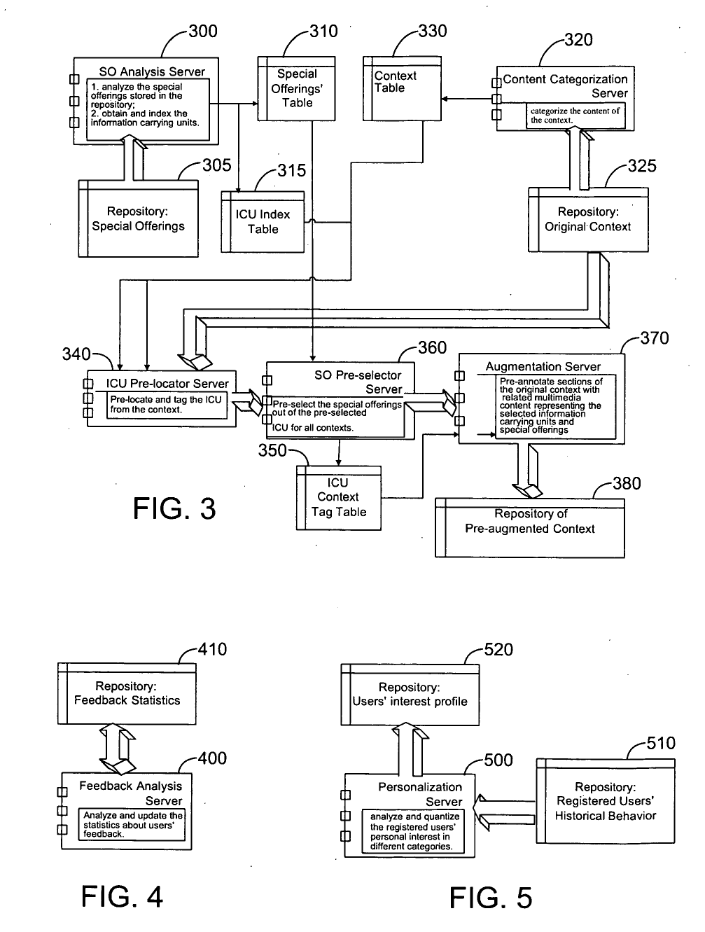

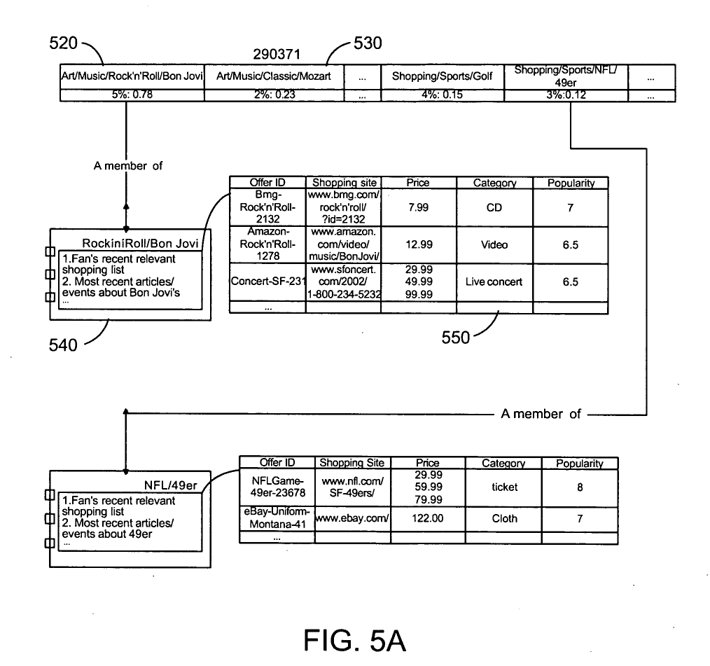

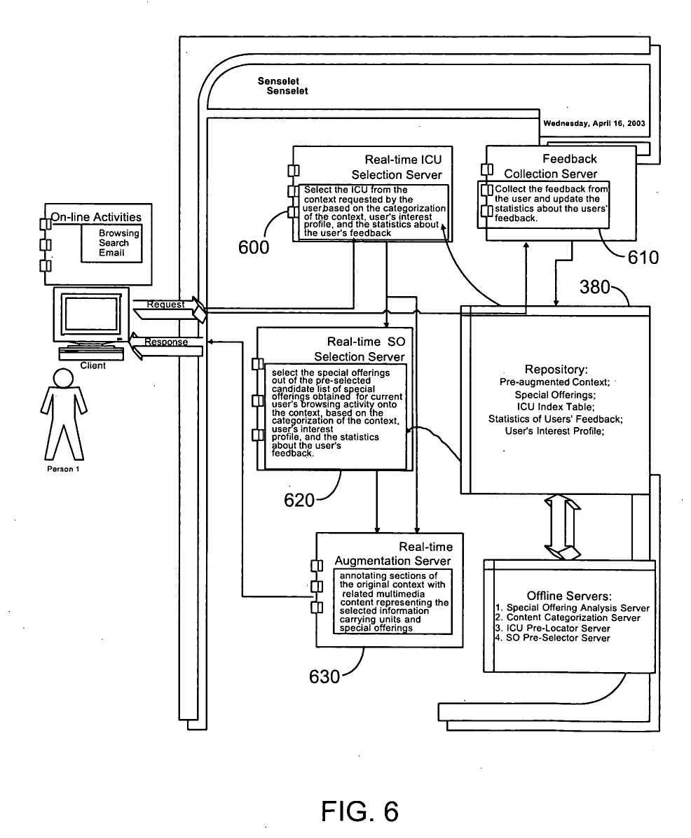

The system and method for dynamically and adaptively delivering special offerings in a network environment may include two independent processes. A first process may include offline context processing as shown in FIG. 3, FIG. 4, and FIG. 5. A second process may include online context processing as shown in FIG. 6.

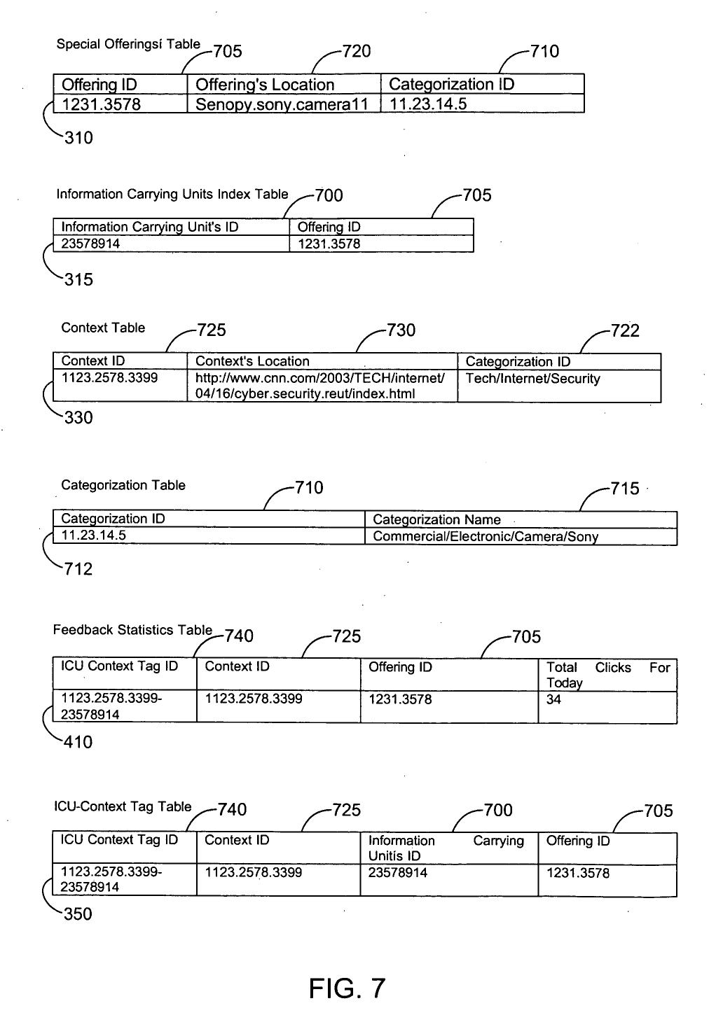

With reference to FIG. 3, a special offering analysis server 300 may be operable to analyze special offerings stored in a special offerings repository 305. Such an analysis may include identifying information carrying units. Information carrying units may include any portion of the stored special offerings including words, sentences, icons, and images which are viewable and have potential meaning to a user. Each identified information carrying unit may be given an identification number 700 (FIG. 7). Each special offering is given an identification number 705 and categorized and given a categorization identification number 710. A categorization name 715 and the categorization identification number 710 may be stored in a categorization table 712. An association of the special offering identification number 705, a location 720 of the special offering's location, and the categorization identification number 710 may be stored in a special offering's table 310.

The special offering analysis server 300 may further be operable to index the information carrying units by associating the information carrying unit's identification number 700 with a special offering identification number 705. The associated information carrying units may be stored in an information carrying units index table 315.

A content categorization server 320 may be operable to categorize the content of a context. A context may include html files stored in a context repository 325. Each context may be given a categorization identification 722 and a context identification number 725. An association of a context location 730, the categorization identification 722, and the context identification number 725 may be stored in a context table 330. The categorization identification 722 may be performed in a conventional manner. Each context may have multiple categorization identifications 722.

An information carrying unit pre-location server 340 may be operable to pre-locate and tag the information carrying units in the contexts stored in the context repository 325 based on the information stored in the information carrying units index table 315 and the contents of the context. An information carrying unit context tag identification number 740 may be assigned to each pre-located information carrying unit.

A special offerings pre-selector server 360 may be operable to process all of the tagged pre-located information carrying units in all of the contexts. For each tagged pre-located information carrying unit, the special offerings pre-selector server 360 may be operable to pre-select the special offerings stored in special offering's table 310 based on the information carrying units stored in the information carrying units index table 315 and the content of the contexts. The tagged pre-located information carrying units may be stored in an information carrying unit context tag table 350 and may include the context identification number 725, the special offering identification number 705, the information carrying unit's identification number 700, and the special offering identification number 705.

A content augmentation server 370 may be operable to insert a template with a tag such as the information carrying unit context tag identification number 740 into locations of the pre-located information carrying units to form a pre-augmented context. The templates may dynamically link to augmented data structures. The templates may be enabled or disabled by a real-time content augmentation server 630 (FIG. 6). The pre-augmented context may be stored in a repository of pre-augmented context 380.

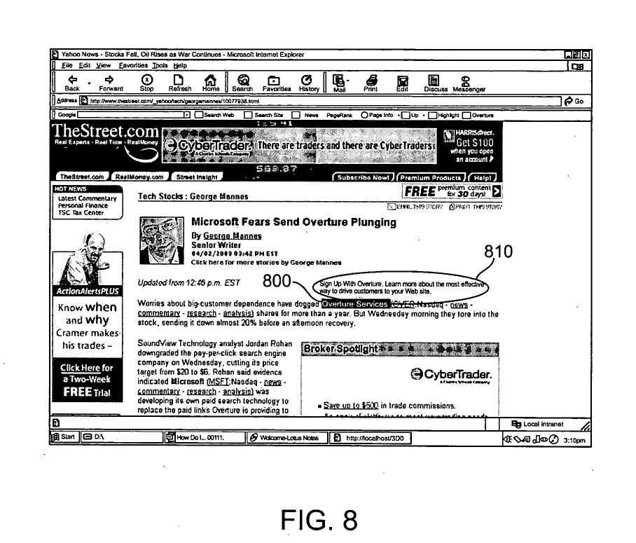

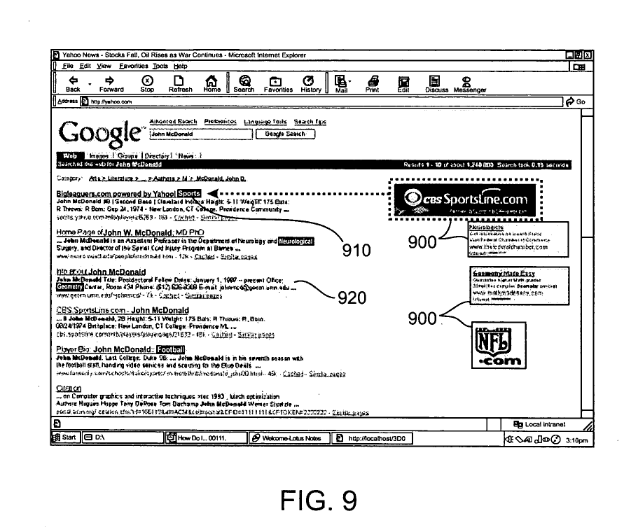

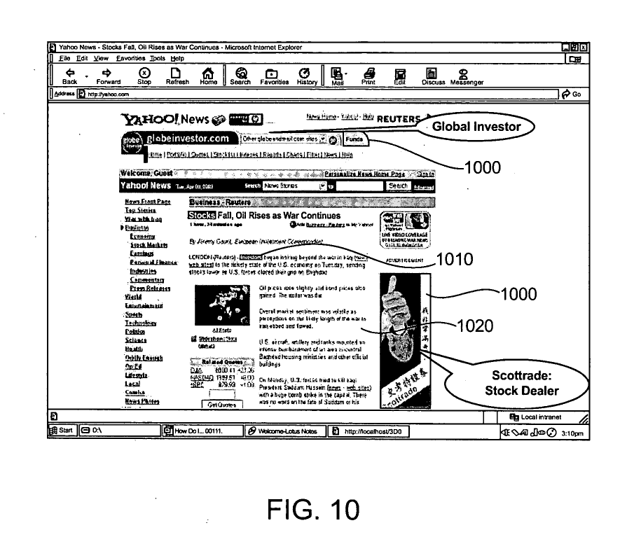

In a preferred embodiment of the invention, the pre-augmented context may include a highlighted information carrying unit 800 such as shown in FIG. 8. When a user's mouse is positioned over the highlighted information carrying unit 800 the special offering 810 associated with the highlighted information carrying unit 800 may be displayed. Alternatively, special offerings 900 and 1000 (FIG. 9 and FIG. 10) associated with highlighted information carrying units 910 and 1010 respectively may be displayed alongside search results 920 and an article 1020 respectively.

Additional offline processes include monitoring and collecting the user's activities when viewing the context. A feedback analysis server 400 shown in FIG. 4 may be operable to monitor, collect, analyze, and update user activity such as which highlighted information carrying units 800, 910, and 1010 the user selects to view. A repository of user feedback statistics 410 may store user feedback statistics.

As shown in FIG. 5, a personalization server 500 may be operable to analyze and quantize a registered user's personal interests in various interest areas to form a user personal interest profile. The user's personal interests are based upon the user's online activities which may be stored in a historical behavior repository 510. A user may be registered with a publisher of context. The user personal interest profiles may be stored in a repository 520.

With reference to FIG. 5A, a user personal interest profile may include a list 520 of categories 530 of interest to the registered user. The list 520 and categories 530 are compiled based upon the registered user's online activities. Within each category 530, a sublist 540 may include specific registered user activities related to respective categories 530. Special offerings 550 may be linked to sublist 540.

Having created pre-augmented context, the system of the invention may be operable to serve an augmented context to the user. A real-time information carrying unit selection server 600 shown in FIG. 6 may be operable to select information carrying units from a context requested by the user from the pre-located information carrying units indexed in the information carrying units index table 315. The selection process may take into account the categorization of the context, the user personal interest profile, and user feedback statistics collected as the user is browsing the context.

A real-time special offering selection server 620 may be operable to select from the pre-selected special offerings stored in special offering's table 310. The selection process may take into account the categorization of the context, the user personal interest profile, and user feedback statistics collected as the user is browsing the context. Conventional optimization, operation research, and statistical modeling methods may be used to select from the pre-selected special offerings.

A real-time augmentation server 630 may be operable to insert a template with a tag such as the information carrying unit context tag identification number 740 into locations of the selected information carrying units to form the augmented context. The augmented context preferably expands upon the pre-selected information carrying units and provides a more attractive and resourceful presentation of the context to the user. The augmented context may be formed by highlighting the selected information carrying units and linking and embedding the selected special offerings in the context. Such linking and embedding may include inserting executable objects in the context. The executable objects may be executed upon the user's moving the mouse over or clicking the highlighted information carrying units.

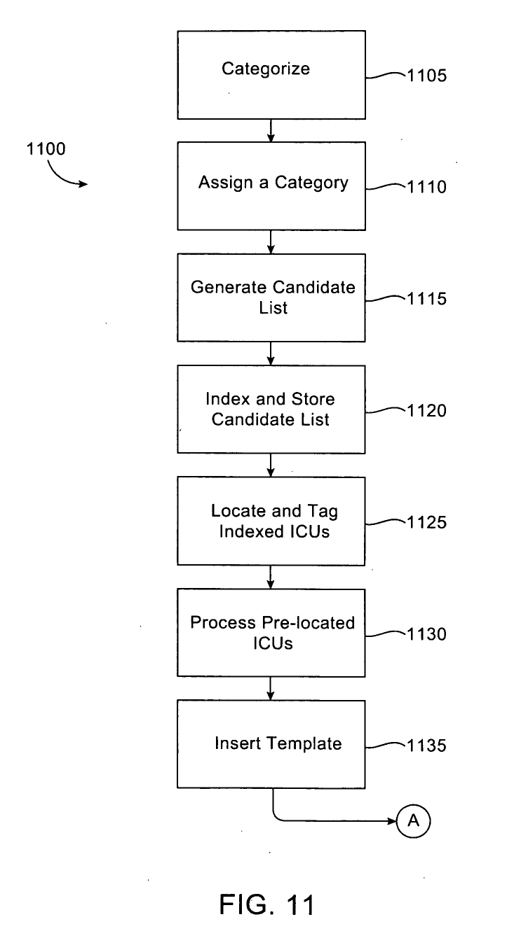

In accordance with a preferred embodiment of the invention, a method for dynamically and adaptively delivering special offerings in a network environment generally designated 1100 and shown in FIG. 11 includes a step 1105 in which the content of the contexts and the special offerings may be categorized. In a step 1110, the content categorization server 320 may assign a categorization to each context and a categorization to each special offering. In a step 1115 a candidate list of information carrying units may be generated from the categorized special offerings. The candidate list of information carrying units may be indexed and stored in a table in a step 1120. In a step 1125, the indexed information carrying units may be located and tagged in each context. The information carrying unit pre-locator server 340 may process each context based upon the indexed information carrying units and the content of the context to determine pre-located information carrying units. The special offering pre-selector server 360 may process all the pre-located information carrying units in a step 1130. For each pre-located information carrying unit, the special offering pre-selector server 360 may pre-select a list of candidates of special offerings for the pre-located information carrying units in each context based on the candidate list of information carrying units and the contents of the context. In a step 1135, the content augmentation server 370 may insert the template with a tag into locations of the pre-located information carrying units.

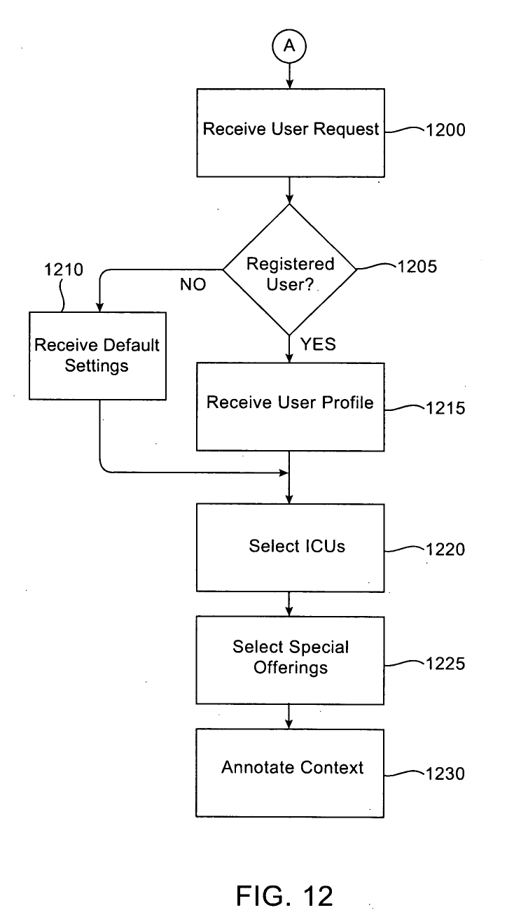

With reference to FIG. 12, method 1100 continues in a step 1200 in which a user request for a context is received in the real-time information carrying unit selection server 600. In a step 1205 it is determined if the user is a registered user. If the user is not a registered user, then in a step 1210 default setting are received. Else in a step 1215 the registered user personal interest profile and the user feedback statistics are received. In a step 1220 information carrying units may be selected from the pre-located information carrying units based upon the content of the context requested, the registered user personal interest profile, and the user feedback statistics. In a step 1225 the real-time special offering selection server 620 may select special offerings from the pre-selected special offerings based upon the categorization of the context requested, the registered user personal interest profile, and the user feedback statistics. Finally, in a step 1230, the real-time content augmentation server 630 may annotate portions of the requested context with multimedia content representing the selected information carrying units and special offerings.

The system and method for dynamically and adaptively delivering special offerings in a network environment of the present invention provides for dynamically augmented context. The user will see selected special offerings which are targeted to his personal interests and which are reflective of the content of the context. Furthermore, presentation of the selected special offerings is not intrusive and does not distract the user's attention from his browsing or searching experience.

We claim:

1. A method for dynamically and adaptively delivering special offerings in a network environment comprising the steps of:
categorizing a content of contexts and special offerings;
analyzing and indexing information carrying units from the special offerings;
pre-locating the indexed information carrying units in the contexts;
associating categorized special offerings with the pre-located information carrying units in the contexts;
tagging the pre-located information carrying units in the contexts;
receiving a request from a user for a context; and
serving the tagged context to the user.

2. The method of claim 1, further comprising receiving a user personal interest profile and tagging the pre-located information carrying units in the contexts in accordance with the received user personal interest profile.

3. The method of claim 2, wherein the user personal interest profile comprises an interest weight assigned to each of a plurality of categories.

4. The method of claim 1, further comprising receiving user feedback statistics and tagging the pre-located information carrying units in the contexts in accordance with the received user feedback statistics.

5. The method of claim 4, wherein the user feedback statistics comprise click rates and transaction rates.

6. The method of claim 1, further comprising receiving a user personal interest profile and user feedback statistics and tagging the pre-located information carrying units in the contexts in accordance with the received user personal interest profile and user feedback statistics.

7. The method of claim 1, further comprising tagging the information carrying units in the contexts in accordance with the categorization of the content of the contexts.

8. The method of claim 1, wherein the contexts include HTML documents.

9. A method for dynamically and adaptively delivering special offerings in a network environment comprising the steps of:
categorizing a content of contexts and special offerings;
analyzing and indexing information carrying units from the special offerings;
receiving a user personal profile;
receiving user feedback statistics;
pre-locating the indexed information carrying units in the contexts based on the content of the contexts, the user personal profile, and user feedback statistics;
associating categorized special offerings with the pre-located information carrying units in the contexts;
tagging the pre-located information carrying units in the contexts;
receiving a request from a user for a context; and
serving the tagged stored context to the user.

10. The method of claim 9, wherein tagging the pre-located information carrying units comprises augmenting the pre-located information carrying unit with additional information.

11. The method of claim 10, wherein the additional information comprises a categorization of the pre-located information carrying unit.

12. The method of claim 10, wherein the additional information comprises a multimedia object.

13. The method of claim 10, wherein the additional information comprises a pop-up advertisement.

14. The method of claim 9, wherein the pre-located information carrying units comprise words.

15. The method of claim 9, wherein the pre-located information carrying units comprise phrases.

16. The method of claim 9, wherein tagging the pre-located information carrying units comprises highlighting the pre-located information carrying units.

17. The method of claim 9, wherein tagging the pre-located information carrying units comprises inserting a link to an executable object.

18. The method of claim 17, wherein the user feedback statistics comprise instances of execution of the executable object by action of the user.

19. A system for dynamically and adaptively delivering special offerings in a network environment comprising:
a special offering analysis server for categorizing special offerings and for identifying and indexing information carrying units in the special offerings;
a content categorization server for categorizing a content of contexts;
an information carrying unit pre-location server for pre-locating and tagging the identified and indexed information carrying units in the contexts;
a special offerings pre-selector server for associating categorized special offerings with the pre-located and tagged information carrying units in the contexts; and
a content augmentation server for inserting a template with a tag into locations of the pre-located and tagged information carrying units in the contexts, the special offering analysis server, content categorization server, information carrying unit pre-location server, and content augmentation server being coupled in the network environment.

20. The system of claim 19, further comprising a personalization server for analyzing and quantizing a registered user's personal interests, the personalization server being coupled to the content augmentation server.

21. The system of claim 20, wherein the registered user's personal interests comprise a user personal interest profile including an interest weight assigned to each of a plurality of categories.

22. The system of claim 19, further comprising a feedback analysis server for monitoring, collecting, analyzing, and updating user activity, the feedback analysis server being coupled to the content augmentation server.

23. The system of claim 22, wherein user activity comprises user feedback statistics including click rates and transaction rates.

24. The system of claim 19, wherein the content augmentation server is operable to insert the template into locations of the pre-located and tagged information carrying units in the contexts in accordance with a user personal interest profile and user feedback statistics.

25. The system of claim 19, wherein information carrying unit pre-location server is operable to tag the information carrying units in the contexts in accordance with the categorization of the content of the contexts

26. The system of claim 19, wherein the contexts include HTML documents.

27. A system for dynamically and adaptively delivering special offerings in a network environment comprising:
a special offering analysis server for categorizing special offerings and for identifying and indexing information carrying units in the special offerings;
a content categorization server for categorizing a content of contexts;
an information carrying unit pre-location server for pre-locating and tagging the identified and indexed information carrying units in the contexts;
a special offerings pre-selector server for associating categorized special offerings with the pre-located and tagged information carrying units in the contexts;
a content augmentation server for inserting a template with a tag into locations of the pre-located and tagged information carrying units in the contexts;
a personalization server for analyzing and quantizing a registered user's personal interests; and
a feedback analysis server for monitoring, collecting, analyzing, and updating user activity, the special offering analysis server, content categorization server, information carrying unit pre-location server, special offerings pre-selector server, content augmentation server, personalization server, and feedback analysis server being coupled in the network environment.

28. The system of claim 27, wherein the information carrying unit pre-location server is operable to augment the pre-located information carrying unit with additional information.

29. The system of claim 28, wherein the additional information comprises a categorization of the pre-located information carrying unit.

30. The system of claim 28, wherein the additional information comprises a multimedia object.

31. The system of claim 28, wherein the additional information comprises a pop-up advertisement.

32. The system of claim 27, wherein the pre-located information carrying units comprise words.

33. The system of claim 27, wherein the pre-located information carrying units comprise phrases.

34. The system of claim 27, wherein the information carrying unit pre-location server is operable to highlight the pre-located information carrying units.

35. The system of claim 27, wherein the information carrying unit pre-location server is operable to insert a link to an executable object.

36. The system of claim 35, wherein the feedback analysis server is operable to monitor instances of execution of the executable object by action of the user.
